(19) United States
(12) Patent Application Publication
(10) Pub. No.: US 2012/0019735 A1
(43) Pub. Date: Jan. 26, 2012

(54) LIQUID CRYSTAL CELL MANUFACTURE

(75) Inventors: Hans Zuidema, Eindhoven (NL); Harry Joseph Cornelus Kuijpers, Haler (NL)

(73) Assignee: KONINKLIJKE PHILIPS ELECTRONICS N.V., EINDHOVEN (NL)

(21) Appl. No.: 13/258,901

(22) PCT Filed: Mar. 22, 2010
(86) PCT No.: PCT/IB2010/051219

§ 371 Date: Sep. 22, 2011

(30) Foreign Application Priority Data
Mar. 25, 2009 (EP) 09156092.0
Mar. 27, 2009 (EP) 09156465.8

(51) Int. Cl. G02F 1/1335; B32B 37/14; B32B 38/00; B32B 37/00

(52) U.S. Cl. 349/15; 349/84; 156/145

(57) ABSTRACT

A method of manufacturing a switchable liquid crystal device uses first and second foils (80,82). A bonding layer (100) is applied to the first foil by a lamination process and bonding takes place at predetermined portions of the bonding layer. These portions define at least one closed boundary (110). Those parts of the bonding layer other than at the predetermined portions are removed. After or during the foils are laminated together, the space enclosed by the closed boundary is filled with liquid crystal material (72) the structure is laminated onto a support substrate (92). The method uses foils as the opposing substrates, so that they can be processed using roll to roll and lamination processes.

### FIELD OF THE INVENTION

This invention relates to liquid crystal cell manufacture, and specifically a cell used as a switchable lens for an autostereoscopic display device.

### BACKGROUND OF THE INVENTION

A known autostereoscopic display device uses a lens arrangement as the imaging arrangement. For example, an array of elongate lenticular elements can be provided extending parallel to one another and overlying the display pixel array, and the display pixels are observed through these lenticular elements.

The lenticular elements are provided as a sheet of elements, each of which comprises an elongate semi-cylindrical lens element. The lenticular elements extend in the column direction of the display panel, with each lenticular element overlying a respective group of two or more adjacent columns of display pixels.

In an arrangement in which, for example, each lenticule is associated with two columns of display pixels, the display pixels in each column provide a vertical slice of a respective two dimensional sub-image. The lenticular sheet directs these two slices and corresponding slices from the display pixel columns associated with the other lenticules, to the left and right eyes of a user positioned in front of the sheet, so that the user observes a single stereoscopic image. The sheet of lenticular elements thus provides a light output directing function.

In other arrangements, each lenticule is associated with a group of four or more adjacent display pixels in the row direction. Corresponding columns of display pixels in each group are arranged appropriately to provide a vertical slice from a respective two dimensional sub-image. As a user's head is moved from left to right, a series of successive, different, stereoscopic views are perceived creating, for example, a look-around impression.

The above described device provides an effective three dimensional display. However, it will be appreciated that, in order to provide stereoscopic views, there is a necessary sacrifice in the horizontal resolution of the device. This sacrifice in resolution is unacceptable for certain applications, such as the display of small text characters for viewing from short distances. For this reason, it has been proposed to provide a display device that is switchable between a two-dimensional mode and a three-dimensional (stereoscopic) mode.

One way to implement this is to provide an electrically switchable lenticular array. In the two-dimensional mode, the lenticular elements of the switchable device operate in a “pass through” mode, i.e. they act in the same way as would a planar sheet of optically transparent material. The resulting display has a high resolution, equal to the native resolution of the display panel, which is suitable for the display of small text characters from short viewing distances. The two-dimensional display mode cannot, of course, provide a stereoscopic image.

In the three-dimensional mode, the lenticular elements of the switchable device provide a light output directing function, as described above. The resulting display is capable of providing stereoscopic images, but has the resolution loss mentioned above.

In order to provide switchable display modes, the lenticular elements of the switchable device are formed of an electro-optic material, such as a liquid crystal material, having a refractive index that is switchable between two values. The device is then switched between the modes by applying an appropriate electrical potential to planar electrodes provided above and below the lenticular elements. The electrical potential alters the refractive index of the lenticular elements in relation to that of an adjacent optically transparent layer. A more detailed description of the structure and operation of the switchable device can be found in U.S. Pat. No. 6,069,650.

The switchable material can be used as the lens element or as the replica.

### SUMMARY OF THE INVENTION

It is an object of the invention to provide a switchable lens arrangement, and a method for its manufacture which reduces manufacturing costs.

This objective is fulfilled with the invention as defined in the independent claims. The dependent claims define advantageous embodiments.

According to the invention, there is provided a method of manufacturing a switchable liquid crystal device, comprising:

providing a first foil;

applying a bonding layer onto the first foil by a first lamination process, wherein bonding with the first foil takes place at predetermined portions of the bonding layer, wherein the bonding layer at the predetermined portions defines at least one closed boundary;

removing those parts of the bonding layer other than at the predetermined portions;

providing a second foil;

applying the second foil onto the bonding layer by a second lamination process, thereby forming at least one structure having a space enclosed by the closed boundary and the first and second foils;

filling the space with liquid crystalline material, and

wherein one or both of the first and second foils comprises an electrode arrangement for controlling the switching of the device.

The method uses a first and second foil as the opposing substrates of a switchable liquid crystal device, so that they can be processed using roll to roll (often also indicated by reel to reel) and lamination processes. Such processes generally involve bending or flexing of at least part of the materials (such as for example the foils) processed. Hence, foils may also be construed as sheets of material that are flexible to the extent processable by such processes. Only after the foils have been joined and the enclosed liquid crystal chambers formed, a support substrate (which may be rigid, for example glass) is introduced to the device. The method of the invention enables a low cost manufacturing and handling process by virtue of the e.g. reel to reel or roll to roll lamination techniques. Such processes are generally also suitable for high speed fabrication as well as large area device fabrication as roll to roll techniques provide a continuous process as opposed to batch wise device manufacturing.

Optionally the method comprises providing the structure onto a support substrate by a third lamination process.

It is noted that the last two steps of the method of the invention, being: applying the second foil onto the bonding layer using a second lamination process, liquid crystal cell filling and the optional step of providing the structure to a support substrate by a third lamination process, can be carried out in a variety of orders. The liquid crystal cell filling can be part of the laminating process of the second foil (as this forms the liquid crystal spaces). If the liquid crystal cellfilling is later, it can be before or after the support substrate is introduced.

The first foil can have a first conductor layer which is preferably transparent on one surface, and the second foil can have a second conductor layer which is preferably transparent on one surface. The two conductor layers then define the control electrodes for switching of the device. In some examples, no patterning of these conductor layers is needed, so that the full device is switched uniformly. In other examples patterning of the electrode layers is preferred for local switching of the device or for being able to provide graded index lenses. Graded index lenses are further explained hereinafter.

The first and second foils can for example comprise polymeric foils, which are preferably transparent Polymer foils may be, amongst others, advantageously tough providing strength to the device, light weight enabling advantageous incorporation of the device in handheld applications and cheap adding to the reduction of manufacturing cost of the device. The foils may be non-birefringent. The support substrate can also comprise a polymeric material, and is preferably non-birefringent.

In one embodiment, applying the bonding layer comprises:

providing a layer of bonding material with release liners on both faces;

patterning the release liner on one face to expose parts of the bonding material corresponding to the predetermined portions, and forming separation regions in the bonding material layer around the exposed parts; and

applying the bonding layer,

and wherein removing parts of the bonding layer comprises removing the parts of the bonding layer having the patterned release liner.

The patterned release liner thus defines where the bonding layer is removed. The separation regions enable the bonding material layer to divide.

In another example, applying the bonding layer comprises:

providing a layer of bonding material with release liners on both faces;
removing the release liner on one face; and

applying the bonding layer,

and wherein removing parts of the bonding layer comprises removing the bonding layer other than where bonding has taken place.

The bonding holds the bonding layer in place at required portions, and the bonding material layer can simply tear to leave the desired bonding material layer portions in place. No patterning of the bonding layer or release layer is then required.

Preferably the method of the invention is a continuous process in view of the advantageous given herebefore. To that end the first and second foils may be provided to the process from a e.g. a roll.

The first and second foils and the bonding layer connected in between can be formed continuously and gathered in the shape of a roll. Such rolls are easy to handle in the factory as well as during transportation to and from the factory.

The structure produced by the method can define a plurality of enclosed liquid crystal cells each of which is defined by a space enclosed by the bonding layer sandwiched in between the first and second foils. The method then further comprises cutting the structure into smaller units having one or more cells each. The cutting can be carried out before laminating onto the support substrate and/or before filling of the cell structures . . . . Hence a simple way of making devices of variable size, i.e. having different number of cells can be provided.

Preferably, the first foil further comprises a patterned structure on the first conductor, and wherein the bonding layer is applied over the patterned structure by the lamination process.

The patterned structure can define a lenticular lens array, for example the liquid crystal material can define lens (such as lenticulars) elements and the patterned structure is a lens replica structure; or the patterned structure can define lenticular lens elements and liquid crystal material defines a lens replica structure. The method can thus be used for manufacturing an switchable lens device in the form of a lens array for employment in an autostereoscopic display device.

The invention further provides a switchable liquid crystal device, comprising:

a first foil;

a bonding layer over the first foil at predetermined positions, the bonding layer at the predetermined positions defining at least one closed boundary

a second foil applied onto the bonding layer; and

liquid crystal material filling the space enclosed by the closed boundary and the first and second foils, and

wherein one or both of the first and second foils comprises an electrode arrangement for controlling the switching of the device and
wherein the device is flexible.

The flexible component is preferably rollable, so that it can be provided on a roll, and can be processed further using roll to roll processes.

In an embodiment the switchable liquid crystal device according to the invention is such that at least part of the device is switchable between at least a first mode providing an optical lens function and a second mode providing a optical pass through without lens function.

For example the lens function may be provided using a Graded index lens structure such as for example described in PCT application PCT/IB2008/05140, or using replica curved lens surfaces in combination with liquid crystal material. Alternatively, the liquid crystal device further comprises a patterned structure on a first conductor (62) of the first foil (80), wherein:

the liquid crystal material (72) defines a lens and the patterned structure (64) is a lens replica structure; or

the patterned structure (64) defines lens and the liquid crystal material (72) defines a lens replica structure. Preferably electrode structures are transparent.

Although, as will be evident from PCT/IB2008/05140, a graded index lens having rigid opposing substrates (corresponding to the first and second foil of the present invention) in principle can have one large space for liquid crystal material over a large area, the boding layer present at predetermined positions such that multiple of such spaces are defined may also serves as a spacer layer defining distance between the two foils in a structure prepared using the method of the invention (see here above) and/or may provide strength to such structure if required. The width of the bonding layer and/or the space for liquid crystal material measured in plane of the foils may be adjusted to obtain the desired strength of a structure and accordingly the device having the structure.

The switchable liquid crystal device may be such that the edges of the patterned bonding layer have an appearance obtainable by tearing the bonding layer. Thus the edges may show a certain roughness as a result of a simple patterning process by which desired portions of the bonding layer and portions to be removed are separated by tearing.

The invention further provides an autostereoscopic display device comprising:

a display panel; and

a switchable liquid crystal device as claimed in claim 13 overlying the display panel.

In an embodiment in the autosteresocopic display device the switchable liquid crystal device according to any of the claims 10 to 13 comprises a non-birefringent substrate (92).

The display panel may be any display panel, such as e.g. a cathode array tube, liquid crystal display panel, light emitting diode panel or plasma display panel, that when combined with the switchable liquid crystal device in its lens function mode is capable of providing 3D images in an autostereoscopic way.

An autostereoscopic display device can comprise a switchable liquid crystal display device of the invention provided on a support substrate. This can be a glass plate, or another polymer layer. The support substrate of the component is preferably a non-birefringent polymer.

### BRIEF DESCRIPTION OF THE DRAWINGS

Embodiments of the invention will now be described, purely by way of example, with reference to the accompanying drawings, in which:

FIG. 1 is a schematic perspective view of a known autostereoscopic display device;

FIGS. 2 and 3 are used to explain the operating principle of the lens array of the display device shown in FIG. 1;

FIG. 4 shows how a lenticular array provides different views to different spatial locations;

FIGS. 5A and 5B show two possible design of LIQUID CRYSTAL device which can be manufactured using the methods of the invention;

FIG. 6 is used to outline in general terms the approach of the invention;

FIGS. 7 to 14 show different stages of a first example of manufacturing process of the invention; and

FIGS. 15 to 21 show different stages of a second example of manufacturing process of the invention.

### DETAILED DESCRIPTION

The invention provides a method of manufacturing a switchable LIQUID CRYSTAL device which uses laminated foils, each having a transparent conductor layer. A bonding layer is applied by a lamination process to one of the foils, with bonding at selected portions which define at least one closed boundary. Parts of the bonding layer other than at the selected portions are removed and the space enclosed by the closed boundary is filled with LIQUID CRYSTAL material. The two-foil structure can be rolled so that low cost roll to roll and lamination processes can be used.

Before describing the invention in detail, an example of known switchable arrangement will first be described.

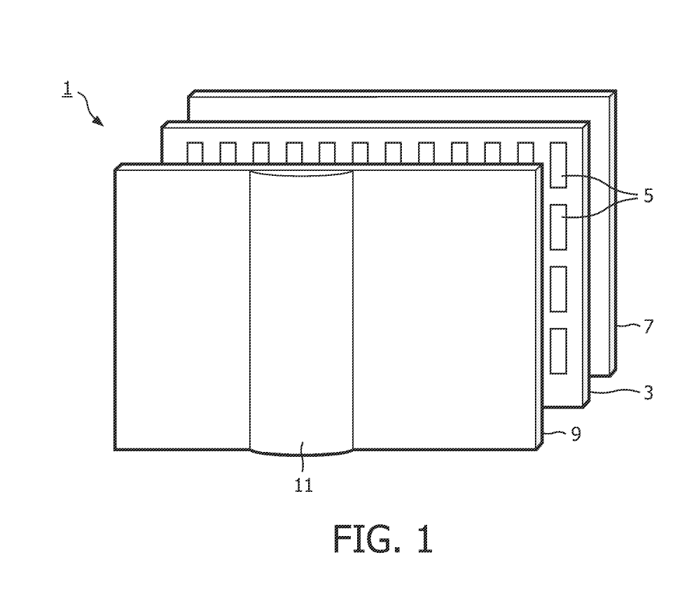

FIG. 1 is a schematic perspective view of a known direct view autostereoscopic display device 1. The known device 1 comprises a liquid crystal display panel 3 of the active matrix type that acts as a spatial light modulator to produce the display.

The display panel 3 has an orthogonal array of display pixels 5 arranged in rows and columns. For the sake of clarity, only a small number of display pixels 5 are shown in the Fig. In practice, the display panel 3 might comprise about one thousand rows and several thousand columns of display pixels 5.

The structure of the liquid crystal display panel 3 is entirely conventional. In particular, the panel 3 comprises a pair of spaced transparent glass substrates, between which an aligned twisted nematic or other liquid crystal material is provided. The substrates carry patterns of transparent indium tin oxide (ITO) electrodes on their facing surfaces. Polarizing layers are also provided on the outer surfaces of the substrates.

Each display pixel 5 comprises opposing electrodes on the substrates, with the intervening liquid crystal material therebetween. The shape and layout of the display pixels 5 are determined by the shape and layout of the electrodes. The display pixels 5 are regularly spaced from one another by gaps.

Each display pixel 5 is associated with a switching element, such as a thin film transistor (TFT) or thin film diode (TFD). The display pixels are operated to produce the display by providing addressing signals to the switching elements, and suitable addressing schemes will be known to those skilled in the art.

The display panel 3 is illuminated by a light source 7 comprising, in this case, a planar backlight extending over the area of the display pixel array. Light from the light source 7 is directed through the display panel 3, with the individual display pixels 5 being driven to modulate the light and produce the display.

The display device 1 also comprises a lenticular sheet 9, arranged over the display side of the display panel 3, which performs a view forming function. The lenticular sheet 9 comprises a row of lenticular elements 11 extending parallel to one another, of which only one is shown with exaggerated dimensions for the sake of clarity.

The lenticular elements 11 are in the form of convex cylindrical lenses, and they act as a light output directing means to provide different images, or views, from the display panel 3 to the eyes of a user positioned in front of the display device 1.

The autostereoscopic display device 1 shown in FIG. 1 is capable of providing several different perspective views in different directions. In particular, each lenticular element 11 overlies a small group of display pixels 5 in each row. The lenticular element 11 projects each display pixel 5 of a group in a different direction, so as to form the several different views. As the user's head moves from left to right, his/her eyes will receive different ones of the several views, in turn.

It has been proposed to provide electrically switchable lens elements, as mentioned above. This enables the display to be switched between 2D and 3D modes.

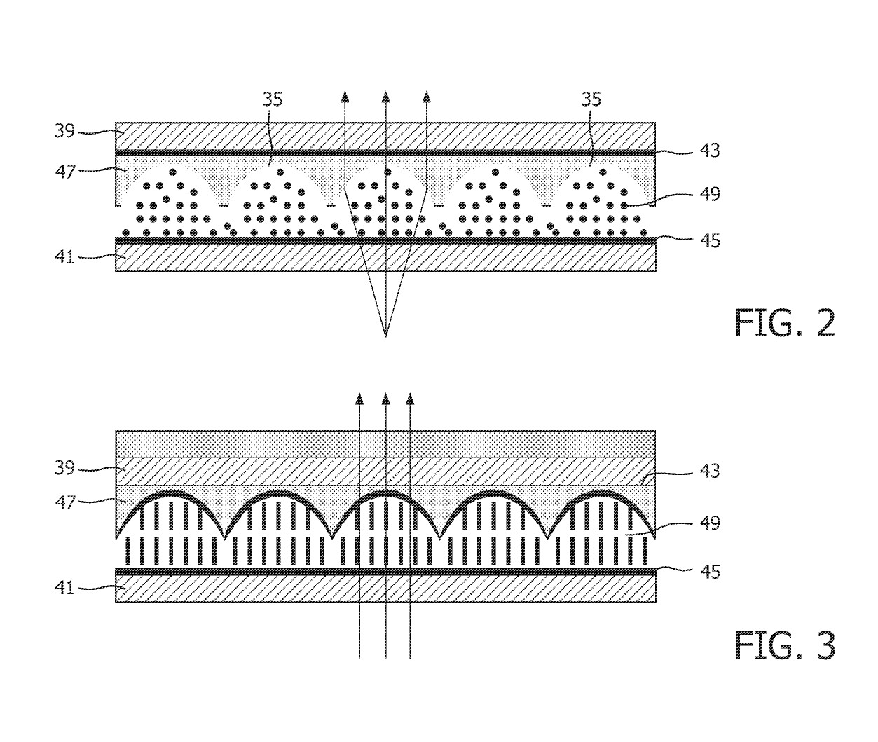

FIGS. 2 and 3 schematically show an array of electrically switchable lenticular elements 35, which can be employed in the device shown in FIG. 1. The array comprises a pair of transparent glass substrates 39, 41, with transparent electrodes 43, 45 formed of indium tin oxide (ITO) provided on their facing surfaces. An inverse lens structure 47, formed using a replication technique, is provided between the substrates 39, 41, adjacent to an upper one of the substrates 39. Liquid crystal material 49 is also provided between the substrates 39, 41, adjacent to the lower one of the substrates 41.

The inverse lens structure 47 causes the liquid crystal material 49 to assume parallel, elongate lenticular shapes, between the inverse lens structure 47 and the lower substrate 41, as shown in cross-section in FIGS. 2 and 3. Surfaces of the inverse lens structure 47 and the lower substrate 41 that are in contact with the liquid crystal material are also provided with an orientation layer (not shown) for orientating the liquid crystal material.

FIG. 2 shows the array when no electric potential is applied to the electrodes 43, 45. In this state, the refractive index of the liquid crystal material 49 is substantially higher than that of the inverse lens array 47, and the lenticular shapes therefore provide a light output directing function, as illustrated.

FIG. 3 shows the array when an alternating electric potential of approximately 50 to 100 volts is applied to the electrodes 43, 45. In this state, the refractive index of the liquid crystal material 49 is substantially the same as that of the inverse lens array 47, so that the light output directing function of the lenticular shapes is cancelled, as illustrated. Thus, in this state, the array effectively acts in a “pass through” mode.

Further details of the structure and operation of arrays of switchable lenticular elements suitable for use in the display device shown in FIG. 1 can be found in U.S. Pat. No. 6,069,650.

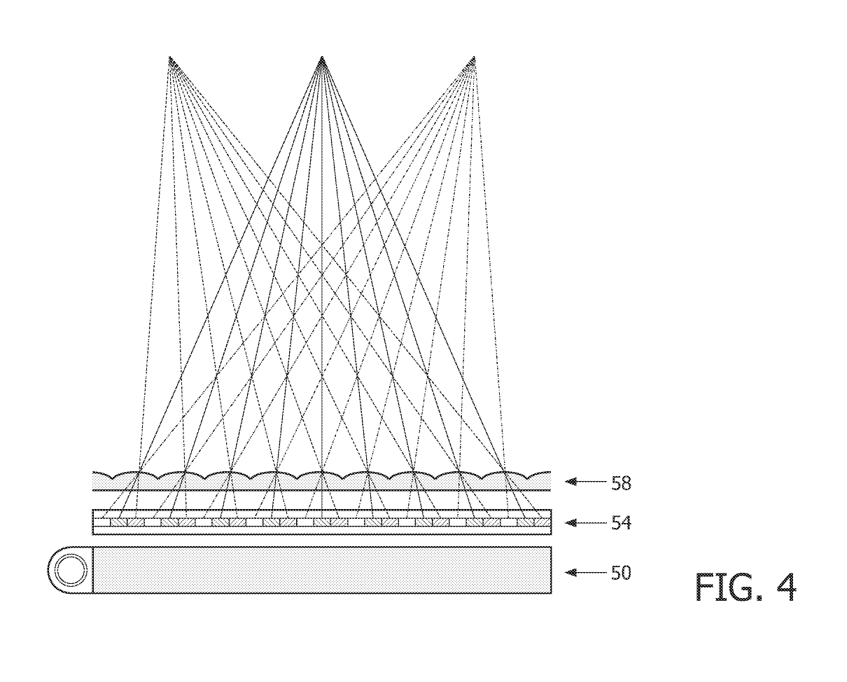

FIG. 4 shows the principle of operation of a lenticular type imaging arrangement as described above and shows the backlight 50, display device 54 such as a LIQUID CRYSTAL and the lenticular array 58. FIG. 4 shows how the lenticular arrangement 58 directs different pixel outputs to different spatial locations.

This invention relates to the manufacturing process for the switchable lenticular array, although the method of the invention has more general applicability to any LIQUID CRYSTAL device manufacture.

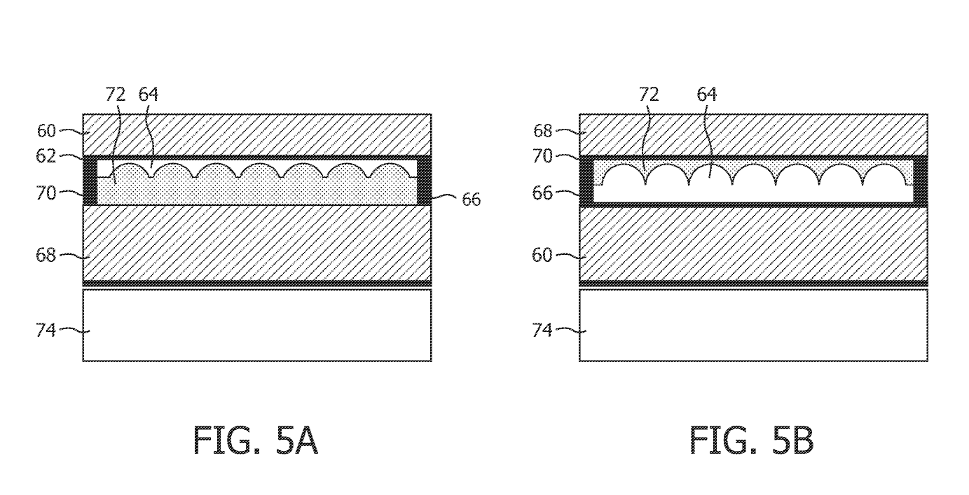

FIGS. 5A and 5B show two possible prior art switchable LIQUID CRYSTAL lens configurations, which can be modified for manufacture using the method of the invention.

The switchable lens device comprises a first glass substrate 60 having a first transparent conductor layer 62 on one surface and a patterned structure 64 on the first transparent conductor 62. The patterned structure 64 defines the lens shape. In FIG. 5A, the patterned structure 64 defines a lens replica shape and the first substrate 60 is the top layer. In FIG. 5B, the patterned structure 64 defines the lens shapes and the first substrate 60 is the bottom layer.

A cell boundary seal 66 defines a closed volume for the LIQUID CRYSTAL material.

A second glass substrate 68 has a second transparent conductor layer 70 on one surface facing the cell. LIQUID CRYSTAL material 72 fills the space enclosed by the closed boundary. The LIQUID CRYSTAL structure overlies an LIQUID CRYSTAL panel 74 (with associated polarizers).

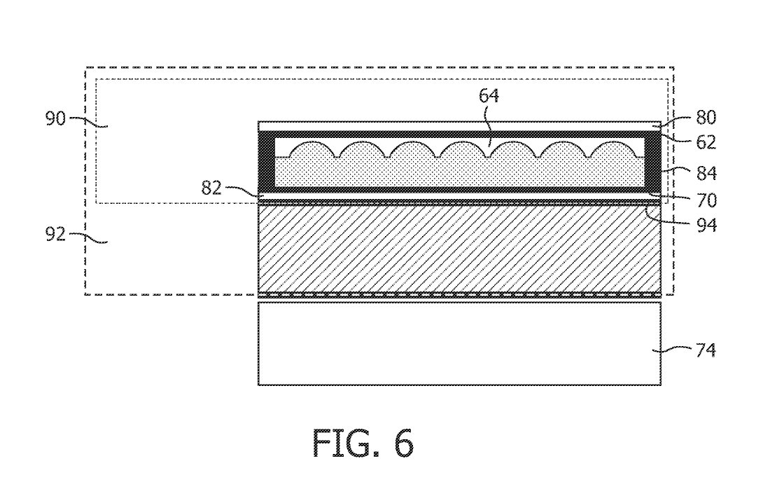

FIG. 6 is used to outline in general terms the approach of the invention, using the configuration of FIG. 5A for example purposes. The glass plates 60, 68 are replaced with flexible foils 80, 82.

The seal is replaced by a patterned bonding layer 84 over the patterned structure 64, and this bonding layer pattern defines the closed volume for the LIQUID CRYSTAL material.

In this arrangement, the top part 90 of the structure can be made using roll to roll processing. The completed top part 90 can then be laminated onto a rigid base 92 with a bonding layer 94 such as a pressure sensitive adhesive (PSA) layer. As will be discussed further below, the rigid base can comprise a glass substrate, but also a polymer layer can be used, preferably a non-birefringent polymer.

The two-foil arrangement 90 is rollable, and this means the manufacture can be performed using roll to roll processes, and lamination processes.

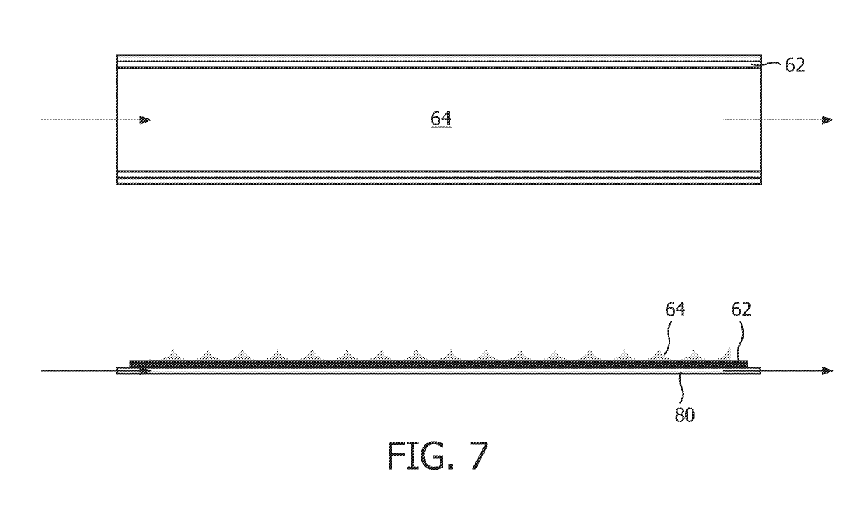

FIGS. 7 to 14 show different stages of a first example of manufacturing process of the invention. In FIGS. 7 to 13, the top part is a plan view and the bottom part is a cross section along the roll length (i.e. the direction of roll driving during the roll to roll process, as shown by arrows in the Figs.).

FIG. 7 shows the first foil 80 with ITO layer 62 and patterned structure 64 for the replica.

The foil is typically a polymer. Examples of material from which the foil can be made are PET (Polyethylene terephthalate), PEN (Polyethylene naphthalate), PES (polyether sulfone), TAC (Triacetyl cellulose), PC (polycarbonate).

The ITO layer is provided on the foil by a sputtering process. Alternative conductive layers can be applied as well, either by sputtering or coating.

The replica structure is made of a UV curable resin (such as Norland-74) and is shaped by a replication process using a source mould (either sheet-to-sheet or roll-to-roll).

The completed foil is formed as a roll.

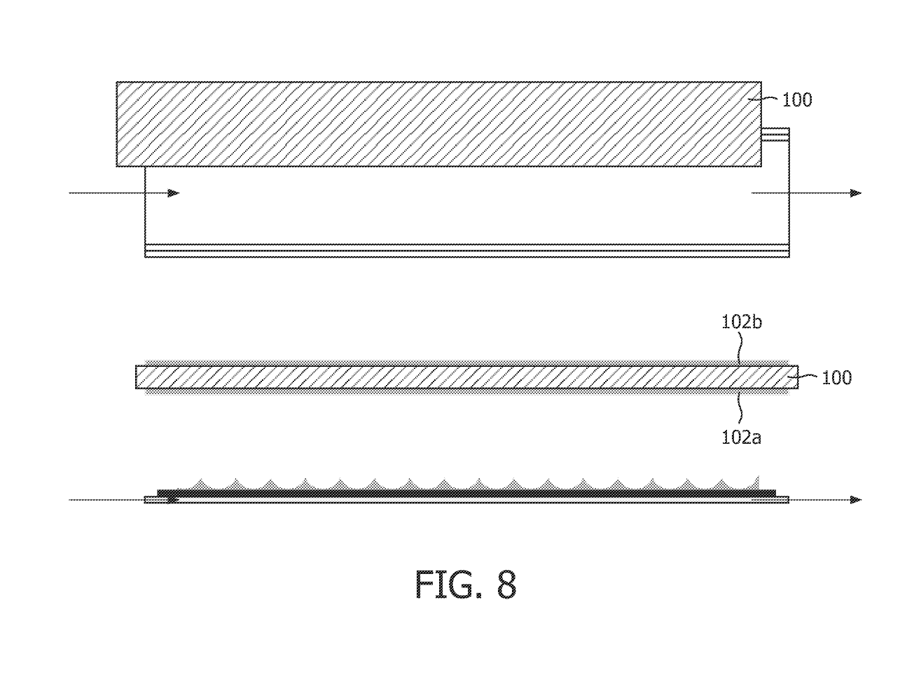

FIG. 8 shows the introduction of a soft seal line adhesive 100 (a bonding material), for example made of 3M 950 or 3M 8211 provided with release liners 102a, 102b, for example made of polyester provided on the opposite faces.

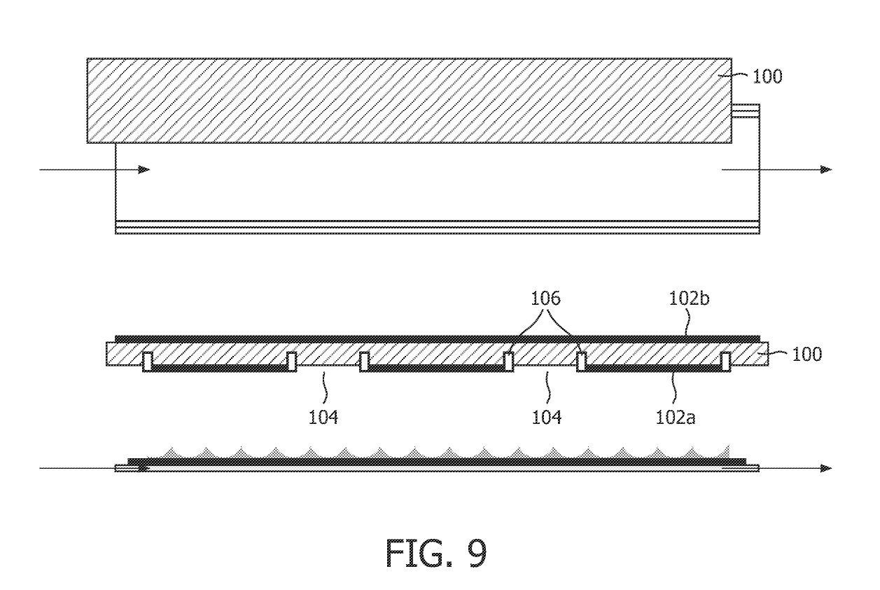

As shown in FIG. 9, the release liner 102a on the side which faces the replica structure is patterned, to expose parts 104 of the bonding material. These parts 104 are to define the cell boundary. Furthermore, the bonding material has separation regions 106 around the exposed parts 104. As will be seen below, these enable the bonding material layer to be separated so that the parts 104 remain in place and the remainder can be removed.

The patterning of the release layer 102a and the formation of the separation regions 106 is carried out by a roll-to-roll cutting process using a stamp and local removal of the release liner.

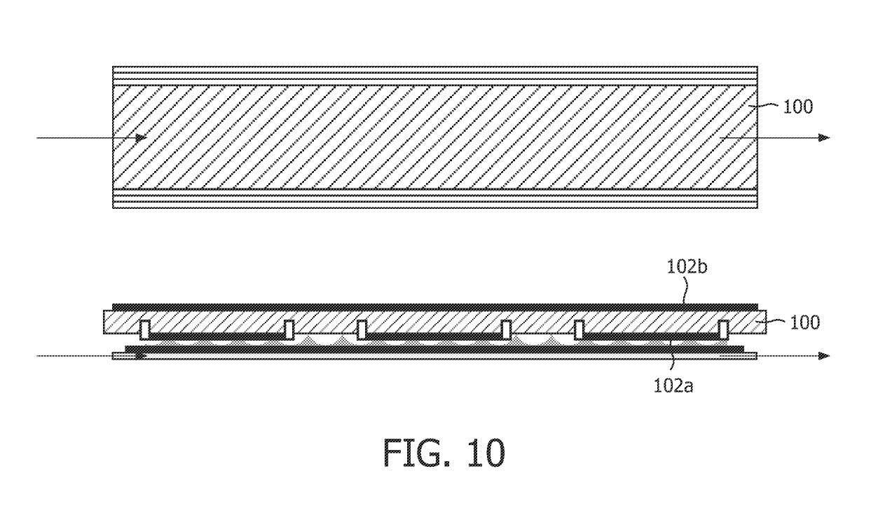

The bonding layer is then applied to the patterned structure by a lamination process as shown in FIG. 10.

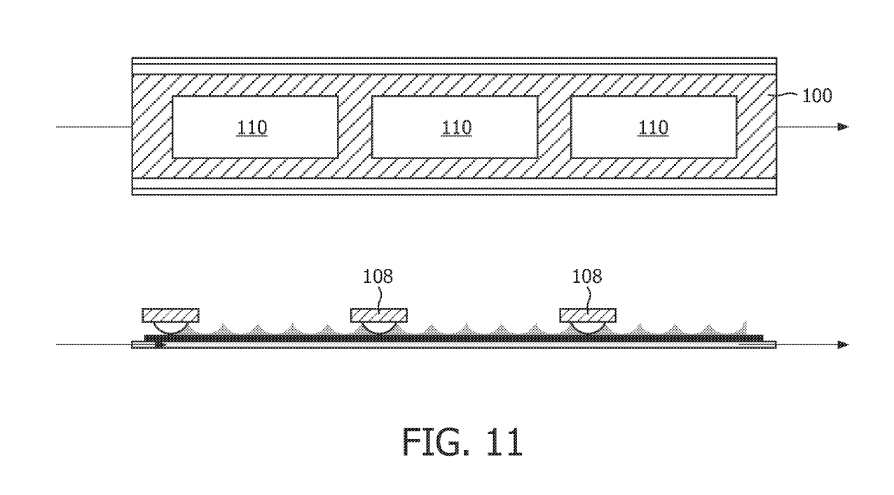

Parts of the bonding layer are then removed, in particular those parts of the bonding layer having the patterned release liner 102a. This is a simple peeling process in which the upper release liner is removed, and it carries with it the desired parts of the bonding layer. The resulting structure is shown in FIG. 11, with bonding layer portions 108. As shown in the plan view, these portions defined closed spaces 110.

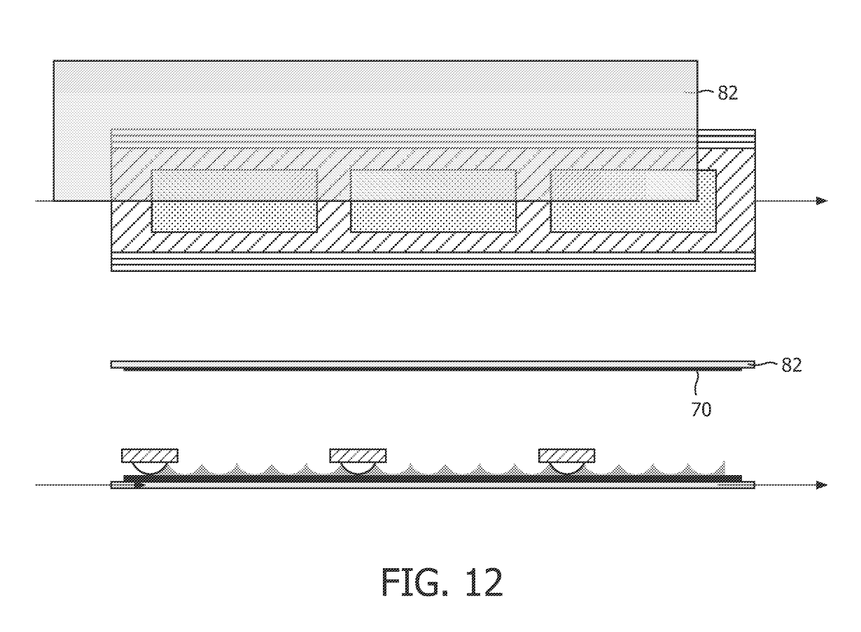

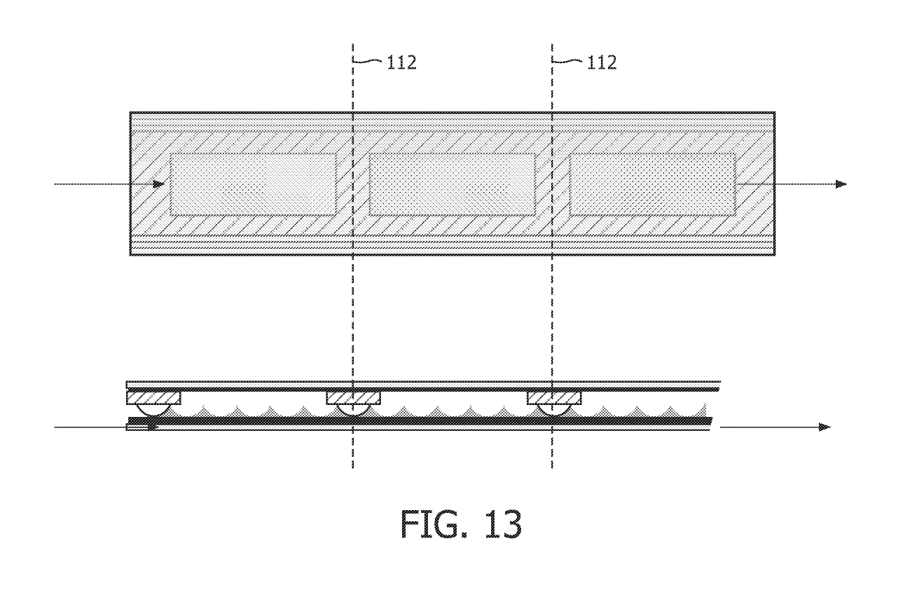

The second foil 82 having the second transparent (ITO) conductor layer 70 on one surface is then provided, as shown in FIG. 12, and the second foil is laminated onto the bonding layer. In the example shown, the second transparent conductor 70 faces the bonding layer portions although it could be the other way around, as the control of the LIQUID CRYSTAL material relies on the electric field rather than direct electrical conduction. The laminated structure is shown in FIG. 13, and it is a rollable structure.

As the laminated foil structure can be formed on a roll, many LIQUID CRYSTAL devices can be provided in series. Individual devices are cut from the roll. For example, a laminated foil component for a single LIQUID CRYSTAL device is defined between the cut lines 112 shown in FIG. 13.

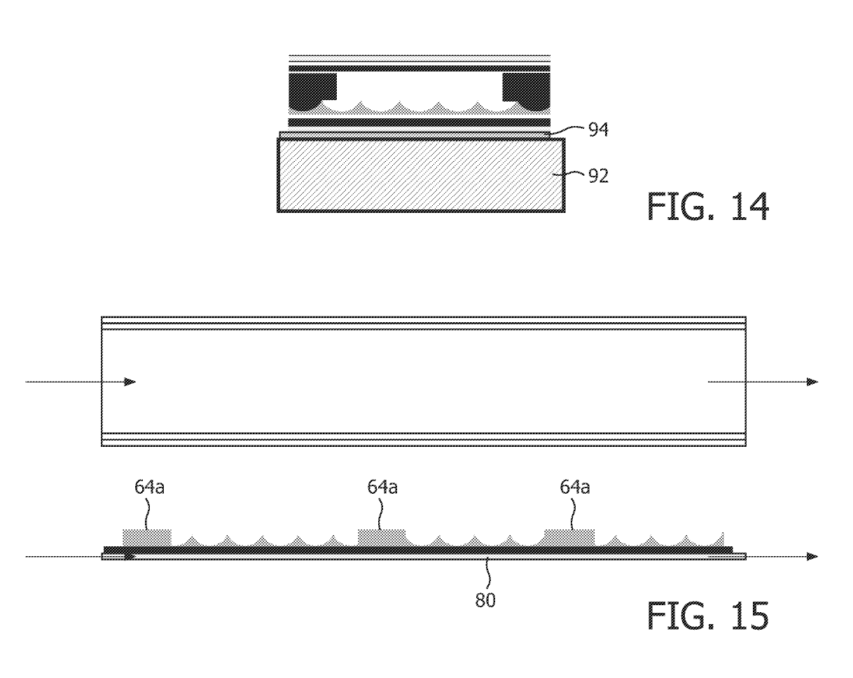

The individual component is laminated onto the support substrate 92 as shown in FIG. 14 for example using a pressure sensitive adhesive 94.

The space enclosed by the closed boundary is filled with LIQUID CRYSTAL material before or after the lamination onto the base plate. The LIQUID CRYSTAL filling may even be carried out during the roll-to-roll cell lamination. Standard LIQUID CRYSTAL-mixtures can be used, although compatibility with other materials in the structure should be ensured.

The support substrate 92 can comprise glass. However, one of the main advantages of the method is that weight is reduced by using foil substrates. Additionally, the support 92 can also be a polymer. The optical effect used to switch between 2D and 3D modes is based on birefringence of the LIQUID CRYSTAL liquid. Therefore, all materials between the LIQUID CRYSTALD 74 and the LIQUID CRYSTAL liquid of the switchable lens arrangement should not have an effect on the optical orientation of the light. Other materials in the structure can have birefringence, as they cannot change the lens effect. Thus, the support 92 is preferably formed of a non-birefringent polymer. In addition, the adhesive layer and polymer foil between the LIQUID CRYSTALD output and the LIQUID CRYSTAL material of the switchable lens arrangement should all be non-birefringent. In this way, the light entering the switchable LIQUID CRYSTAL lens system has known orientation, in order to enable the desired lens effect to be achieved.

The complete switchable lens structure can thus be formed without the need for any glass layers.

FIGS. 15 to 21 show different stages of a second example of manufacturing process of the invention. In these Figs., the top part is again a plan view and the bottom part is a side view.

FIG. 15 corresponds to FIG. 7 and shows the first foil 80. The replica structure 64 has flat island parts 64a at the locations where sealing will be performed, and the reason for these will be apparent from the description below.

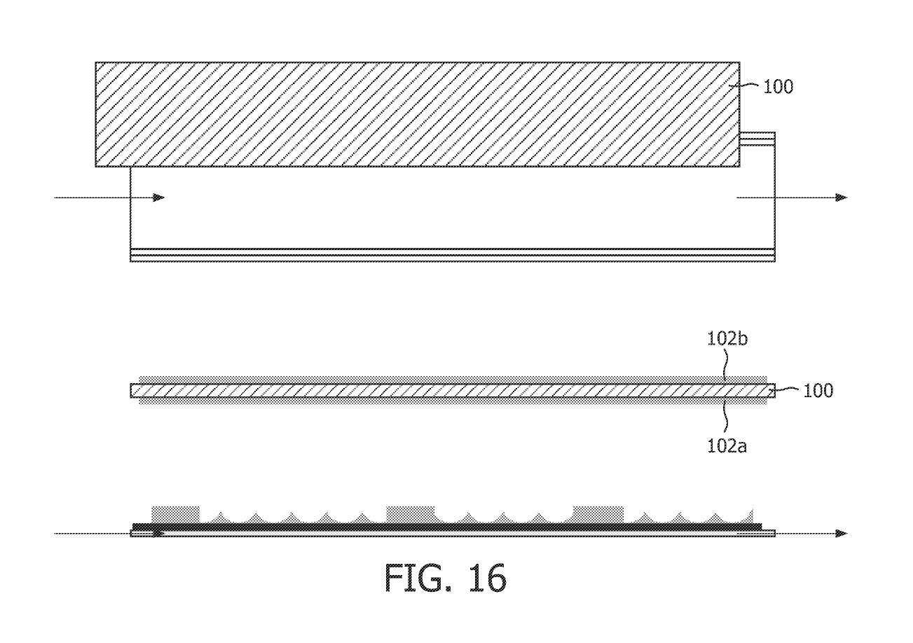

FIG. 16 corresponds to FIG. 8 and shows the bonding material layer 100 with release layers on each side.

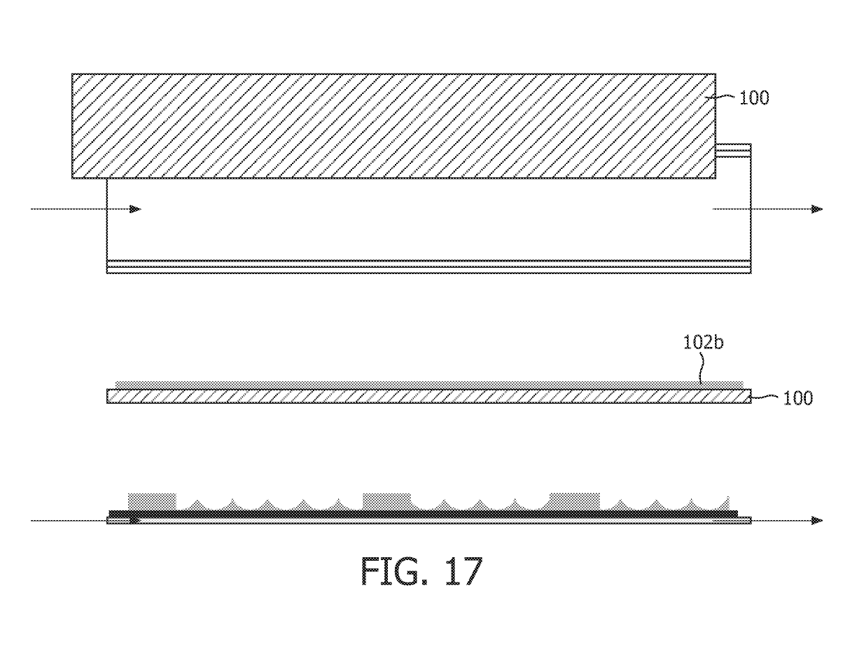

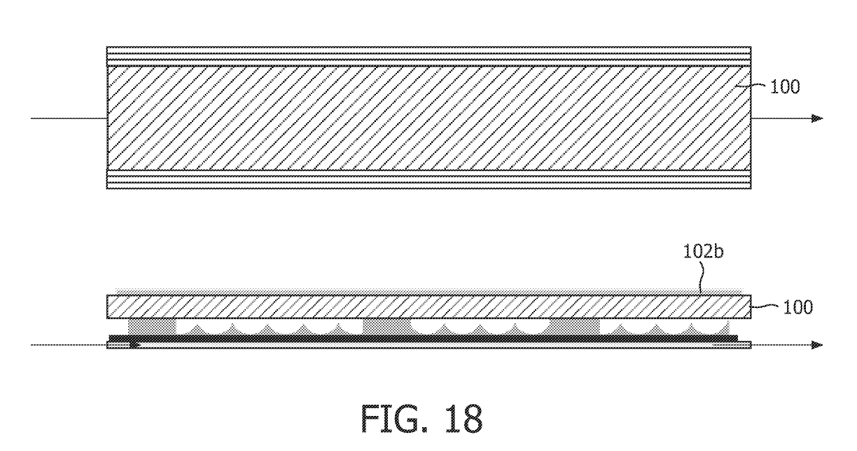

FIG. 17 shows that the lower release layer 102a is completely removed, and the bonding layer is then applied to the patterned replica structure as shown in FIG. 18.

The bonding layer has smaller cohesion than adhesion. By removing the upper release liner, the material layer is torn apart, as the parts of the bonding layer on the islands 64a have greater adhesion strength than the cohesion within the bonding layer.

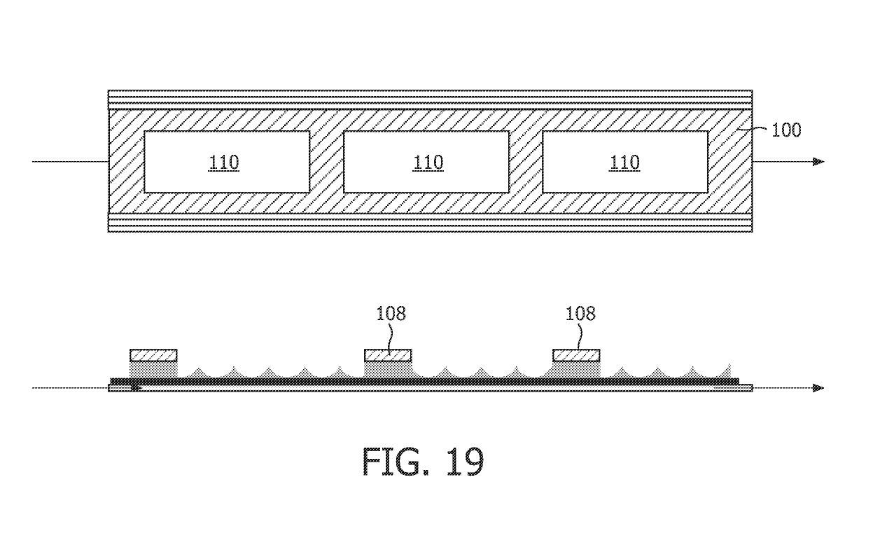

The resulting structure is shown in FIG. 19. This corresponds to FIG. 11 and shows the bonding layer portions 108 which define closed spaces 110.

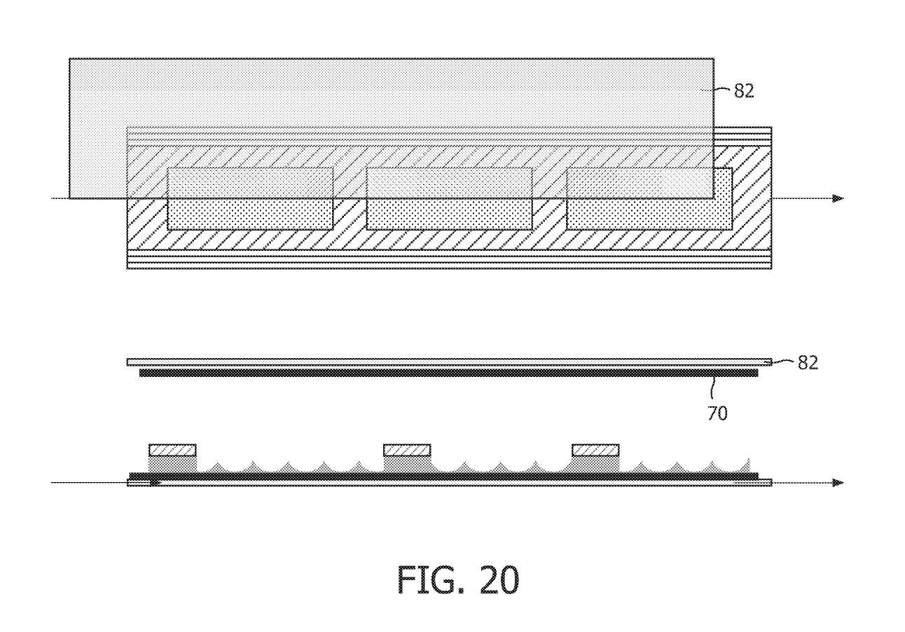

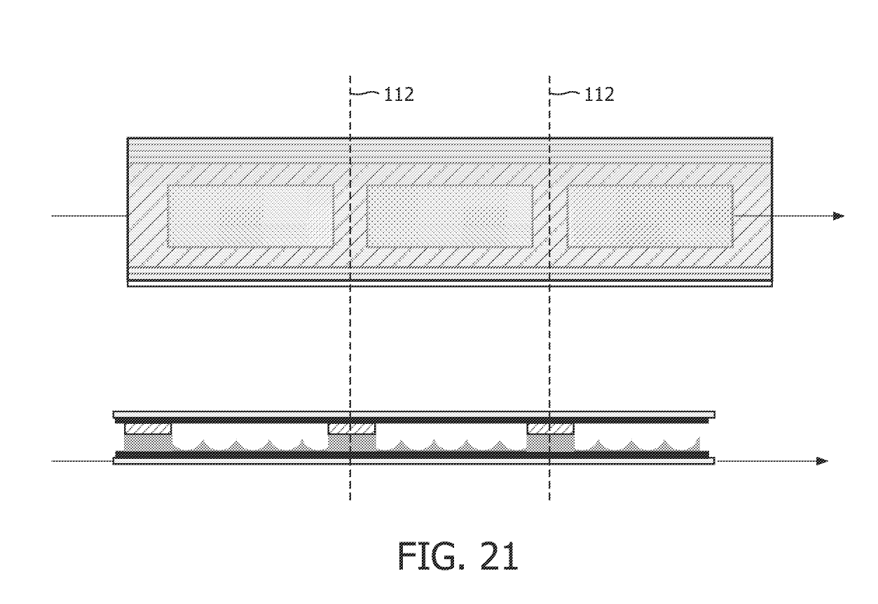

FIG. 20 corresponds to FIG. 12 and shows the introduction of the second foil 82. FIG. 21 corresponds to FIG. 13 and shows the laminated structure. The same cutting, cell filling and lamination onto a rigid support as described above are then carried out.

This method uses tearing of the bonding material layer when removing the unwanted parts of the layer, and relies on the strong adhesion with the islands compared to the cohesive properties of the layer itself. This tearing gives rise to an imperfect edge to the cell boundary, but this has no impact on the optical performance of the device.

The invention is of particular interest for the switchable lens structure of an autosterescopic display device. However, it applies generally to LIQUID CRYSTAL cell manufacture, and is of particular interest for applications where pixellated control is not required. Instead, a single upper and lower control electrode can be used. This can be used for example for switchable windows, privacy screens and other such applications.

Although many examples require an upper and a lower electrode, the control electrodes can all be in one plane, i.e. on only one of the flexible foils. For example, switchable graded refractive index lenses can be formed using a co-planar electrode pattern. The construction of several of such examples is described in detail in PCT application PCT/IB2008/05140 which is incorporated by reference in the present application. For example in a device according to the description of FIG. 1 of PCT/IB2008/05140, the lens function in one mode the device is described in detail and in short achieved using the electrodes 5 and 6 that upon application of a voltage difference induce reorientation of the Liquid crystal material 2 in the region 10a, b and c such that the local reorientation has the shape and function of a lens. The device of FIG. 1, when adjusted to the present invention would have layers 3 and 4 made of foil, preferably transparent polymer film. The person skilled in the art will be able to further adjust by providing the bonding layer etc according to the invention. Further switchable liquid crystal devices of this type are described in PCT/IB2008/05140 with reference to the FIGS. 14 and 15 therein. Moreover the application of such switchable devices in autostereoscopic displays is also outlined in detail in the description of for example FIG. 23 of PCT/IB2008/05140 showing an example of an autostereoscopic device having a liquid crystal display panel 172 with a switchable liquid crystal device 174. The electric field lines between one pattern at one potential and another pattern at another potential can be used to provide the desired LIQUID CRYSTAL switching. Thus, it is not essential for both foils to be provided with electrodes. In this example, the single electrode layer will however need to be patterned.

The lamination processes that can be used have not been described in detail as they will be conventional. Similarly, the roll to roll processes that can be used have not been described in detail as they will be conventional.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A method of manufacturing a switchable liquid crystal device, comprising:
providing a first foil (80);
applying a bonding layer (100) onto the first foil by a first lamination process, wherein bonding with the first foil takes place at predetermined portions (108) of the bonding layer, wherein the bonding layer at the predetermined portions defines at least one closed boundary (110);
removing those parts of the bonding layer other than at the predetermined portions (108);
providing a second foil (82);
applying the second foil (82) onto the bonding layer (100) by a second lamination process, thereby forming at least one structure having a space enclosed by the closed boundary (110) and the first and second foils;
filling the space with liquid crystalline material (72), and
wherein one or both of the first and second foils comprises an electrode arrangement for controlling the switching of the device.

2. A method as claimed in claim 1, wherein the first foil has a first transparent conductor layer (62) on one surface, and wherein the second foil has a second transparent conductor layer (70) on one surface.

3. A method as claimed in claim 1, wherein the first and second foils (80,82) comprise polymeric foils, and wherein the support substrate comprises a non-birefringent material.

4. A method as claimed in claim 1, wherein applying the bonding layer (100) comprises:
providing a layer of bonding material (100) with release liners (102a,102b) on both faces;
patterning the release liner (102a) on one face to expose parts (104) of the bonding material corresponding to the predetermined portions, and forming separation regions (106) in the bonding material layer around the exposed parts; and
applying the bonding layer (100),
and wherein removing parts of the bonding layer comprises removing the parts of the bonding layer having the patterned release liner (102a).

5. A method as claimed in claim 1, wherein applying the bonding layer comprises:
providing a layer of bonding material (100) with release liners (102a,102b) on both faces;
removing the release liner (102a) on one face; and
applying the bonding layer (100),
and wherein removing parts of the bonding layer comprises removing the bonding layer other than where bonding has taken place.

6. A method as claimed in claim 1, wherein the first and second foils (80,82) when connected together are formed as a roll.

7. A method as claimed in claim 1, wherein the predetermined portions define a plurality of closed boundaries (110), thereby forming a plurality of structures each having a space enclosed by the closed boundary (110) and the first and second foils and comprising the further step of cutting at least part of the plurality of structures into individual structures or into subsets of structures.

8. A method as claimed in claim 1, wherein the first foil (80) further comprises a patterned structure (64) on the first conductor (62), and wherein the bonding layer (100) is applied over the patterned structure by the lamination process, wherein the patterned structure forms part of a lens array.

9. A method as claimed in claim 8, wherein:
the liquid crystal material (72) defines a lens or lenses and the patterned structure (64) is a lens or lenses replica structure; or
the patterned structure (64) defines a lens or lenses and liquid crystal material (72) defines a lens or lenses replica structure.

10. A switchable liquid crystal device, comprising:
a first foil (80);
a bonding layer (100) over the first foil at predetermined positions, the bonding layer at the predetermined positions defining at least one closed boundary (110);
a second foil (82) applied onto the bonding layer; and
liquid crystal material (72) filling the space enclosed by the closed boundary and the first and second foils, and
wherein one or both of the first and second foils comprises an electrode arrangement for controlling the switching of the device and
wherein the device is flexible.

11. A switchable liquid crystal device according to claim 10 wherein at least part of the device is switchable between at least a first mode providing an optical lens function and a second mode providing a optical pass through without lens function.

12. A switchable liquid crystal device as claimed in claim 10, wherein the edges of the patterned bonding (100) layer have an appearance obtainable by tearing the bonding layer.

13. A switchable liquid crystal device as claimed in claim 10, wherein the liquid crystal device further comprises a patterned structure (64) on a first transparent conductor (62) of the first foil (80), wherein:
the liquid crystal material (72) defines a lens and the patterned structure (64) is a lens replica structure; or
the patterned structure (64) defines lens and the liquid crystal material (72) defines a lens replica structure.

14. An autostereoscopic display device comprising:
a display panel (74); and
a switchable liquid crystal device as claimed in claim 13 overlying the display panel.

15. An autostereoscopic display device as claimed in claim 14, wherein the switchable liquid crystal device comprises a non-birefringent substrate (92).
